(19) United States
(12) Patent Application Publication
(10) Pub. No.: US 2024/0152266 A1
(43) Pub. Date: May 9, 2024

(54) TERMINAL CONTROL METHOD, SYSTEM AND APPARATUS, COMPUTER DEVICE, AND STORAGE MEDIUM

(71) Applicant: VITALINK INDUSTRY (SHENZHEN) CO., LTD., Shenzhen, Guangdong (CN)

(72) Inventors: Ren XU, Shenzhen (CN); Ning ZHAO, Shenzhen (CN); Feng ZHOU, Shenzhen (CN); Kefeng LI, Shenzhen (CN); Chang WU, Shenzhen (CN); Wei WANG, Shenzhen (CN)

(21) Appl. No.: 17/769,521

(22) PCT Filed: Dec. 25, 2019
(86) PCT No.: PCT/CN2019/128460

§ 371 Date: Nov. 8, 2022

(30) Foreign Application Priority Data
Oct. 16, 2019 (CN) 201910984145.2

(51) Int. Cl. G06F 3/0488; G06F 3/0484; H04W 76/10

(52) U.S. Cl. CPC G06F 3/0488; G06F 3/0484; H04W 76/10

(57) ABSTRACT

Provided are a terminal control method, system and apparatus, a computer device, and a storage medium. The method comprises: establishing connection with a controlled terminal; acquiring a first interaction interface of the controlled terminal; displaying a second interaction interface, wherein the second interaction interface matches the first interaction interface of the controlled terminal; receiving a touch-control operation of a user on the second interaction interface; according to the touch-control operation, controlling the controlled terminal to perform a touch control response; acquiring a first touch-control response interface of the controlled terminal, wherein the first touch-control response interface is an interface displayed by the controlled terminal after performing a touch control response; and displaying a second touch-control response interface, wherein the second touch-control response interface matches the first touch-control response interface of the controlled terminal.

### CROSS REFERENCE TO RELATED APPLICATION

The present disclosure is based on and claims priority to Chinese Patent Application with No. 201910984145.2 and filed on Oct. 16, 2019, the content of which is expressly incorporated herein by reference in its entirety.

### TECHNICAL FIELD

The present disclosure relates to the field of communication, and particularly to a terminal control method, system and apparatus, a computer device and a storage medium.

### BACKGROUND

With the development of communication technology, people's demand for communication products is increasingly complex and diversified, which puts forward higher requirements for the communication system in terms of the transmission rate, the storage capacity and the signal processing capability. Based on this, with the emergence of technologies such as wearable devices and smart watches, terminal devices in the communication system gradually tends to be miniaturized. In addition to implementing the complex and diverse functions, it is also necessary to reduce the weight and volume of each functional module as much as possible to facilitate the portability.

Traditionally, in order to reduce the complexity of the terminal and improve the portability, a processor chip with higher integration can be used in each functional module of the terminal to improve efficiencies of data processing and transmission. Alternatively, the communication algorithm is optimized to reduce the error rate of the data transmission, improve the transmission rate, and save the storage space.

However, with the continuous increase of people's demands, the above-mentioned methods have limited effect on improving the complexity of the terminal; and the terminal device always needs to face the problems of increasing weight and volume and inconvenience to carry during the development process.

Therefore, the terminal has the problems of larger weight and volume, and dissatisfied portability.

### SUMMARY

In view of this, for the problems of larger weight and volume, and dissatisfied portability of the communication terminals, it is necessary to provide a terminal control method, system, and apparatus, a computer device and a storage medium.

A terminal control method is provided, including:
establishing a connection with a control led terminal;
acquiring a first interactive interface of the controlled terminal;
displaying a second interactive interface, the second interactive interface matching the first interactive interface of the controlled terminal;
receiving a touch operation performed by a user on the second interactive interface;
controlling the controlled terminal to perform a touch response according to the touch operation;
acquiring a first touch response interface of the controlled terminal, the first touch response interface being an interface displayed after the controlled terminal performs the touch response;
displaying a second touch response interface, the second touch response interface matching the first touch response interface of the controlled terminal.

In an embodiment, the controlling the controlled terminal to perform the touch response according to the touch operation includes:
obtaining touch operation data according to the touch operation;
obtaining touch operation data of the controlled terminal according to the touch operation data, in which the touch operation data of the controlled terminal is configured to perform the touch operation on the first interactive interface of the controlled terminal;
transmitting the touch operation data of the controlled terminal to the controlled terminal, for performing the touch response by the controlled terminal according to the touch operation data of the controlled terminal, to obtain the first touch response interface of the controlled terminal.

In an embodiment, the establishing the connection with the controlled terminal includes:
establishing the connection with the controlled terminal through Bluetooth or a custom wireless protocol.

In an embodiment, the establishing the connection with the controlled terminal further includes:
acquiring an identity code;
transmitting the identity code to the controlled terminal, for establishing the connection by the controlled terminal after successfully verifying the identity code.

In an embodiment, the acquiring the first interactive interface of the controlled terminal includes:
acquiring interactive interface screenshot data, the interactive interface screenshot data being data obtained by performing screenshot of the first interactive interface of the controlled terminal;
processing the interactive interface screenshot data to obtain processed interactive interface screenshot data which is configured to display the second interactive interface.

In an embodiment, the acquiring the first touch response interface of the controlled terminal includes:
acquiring response interface screenshot data, the response interface screenshot data being data obtained by performing screenshot of the first touch response interface of the controlled terminal;
processing the response interface screenshot data to obtain processed response interface screenshot data, in which the processed response interface screenshot data is configured to display the second touch response interface.

A terminal control method is provided, including:
establishing a connection with a control center, wherein the connection is established between the control center and a controlled terminal;
acquiring a first interactive interface of the controlled terminal through the control center;
displaying a second interactive interface, the second interactive interface matching the first interactive interface of the controlled terminal;
receiving a touch operation performed by a user on the second interactive interface;
transmitting the touch operation to the control center, in which the control center is configured to control the controlled terminal to perform a touch response according to the touch operation;
acquiring, through the control center, a first touch response interface of the controlled terminal, in which the first touch response interface is an interface displayed after the controlled terminal performs the touch response;
displaying a second touch response interface, the second touch response interface matching the first touch response interface of the controlled terminal.

In an embodiment, the establishing the connection with the control center includes:
establishing the connection with the control center via a 3G/4G/5G network or

In an embodiment, the establishing the connection with the control center further includes:
acquiring an identity code;
transmitting the identity code to the control center; forwarding, through the control center, the identity code to the controlled terminal, for establishing the connection by the controlled terminal after successfully verifying the identity code.

In an embodiment, the acquiring the first interactive interface of the controlled terminal through the control center includes:
receiving a manipulation request of the controlled terminal, in which the manipulation request of the controlled terminal is configured to request a manipulation of the controlled terminal by a user;
accessing the control center according to the manipulation request of the controlled terminal, and obtaining the first interactive interface of the controlled terminal.

In an embodiment, the acquiring the first interactive interface of the controlled terminal through the control center further includes:
acquiring interactive interface screenshot data through the control center, in which the interactive interface screenshot data is data obtained by performing screenshot of the first interactive interface of the controlled terminal;
processing the interactive interface screenshot data to obtain processed interactive interface screenshot data, in which the interactive interface screenshot data acquired by the control center is configured to display the second interactive interface.

In an embodiment, the acquiring the first touch response interface of the controlled terminal through the control center includes:
acquiring response interface screenshot data through the control center, in which the response interface screenshot data being data obtained by performing screenshot of the first touch response interface of the controlled terminal;
processing the response interface screenshot data to obtain processed response interface screenshot data; in which the processed response interface screenshot data is configured to display the second touch response interface.

A terminal control method is provided, including:
establishing a connection with a control terminal;
transmitting a first interactive interface of the controlled terminal to the control terminal;
performing a touch response according to a touch operation, and obtaining a first touch response interface;
transmitting the first touch response interface to the control terminal.

In an embodiment, the transmitting the first interactive interface of the controlled terminal to the control terminal includes:
performing screenshot of the first interactive interface of the controlled terminal and obtaining interactive interface screenshot data;
transmitting the interactive interface screenshot data to the control terminal.

In an embodiment, the transmitting the first touch response interface to the control terminal includes:
performing screenshot of the first touch response interface and obtaining the response interface screenshot data;
transmitting the response interface screenshot data to the control terminal.

A terminal control method is provided, including:
establishing a connection with a control center, in which the connection is established between the control center and a control terminal;
transmitting a first interactive interface of a controlled terminal to the control terminal through the control center;
performing a touch response according to a touch operation, and obtaining a first touch response interface;
transmitting, through the control center, the first touch response interface to the control terminal.

In an embodiment, the transmitting, through the control center, the first interactive interface of the controlled terminal to the control terminal includes:
performing screenshot of the first interactive interface of the controlled terminal, and obtaining interactive interface screenshot data;
transmitting, through the control center, the interactive interface screenshot data to the control terminal.
In an embodiment, the transmitting, through the control center, the first touch response interface to the control terminal includes:
performing screenshot of the first touch response interface, and obtaining the response interface screenshot data;
transmitting, through the control center, the response interface screenshot data to the control terminal.

A terminal control system is provided, including: a control terminal and a controlled terminal, the controlled terminal being configured to display a first interactive interface;
in which the control terminal is configured to establish a connection with the controlled terminal;
the controlled terminal is configured to transmit the first interactive interface to the control terminal;
the control terminal is configured to display a second interactive interface matching the first interactive interface;
the control terminal is configured to receive a touch operation performed by a user on the second interactive interface;
the control terminal is configured to control the controlled terminal to perform a touch response according to the touch operation;
the controlled terminal is configured to transmit the first touch response interface to the control terminal;
the controlled terminal is configured to display a second touch response interface matching the first touch response interface of the controlled terminal.

A terminal control system is provided, including: a control terminal, a control center and a controlled terminal;
the control center is configured to establish a connection with the control terminal, and establish a connection with the controlled terminal;
the controlled terminal is configured to transmit a first interactive interface to the control center;
the control center is configured to forward the first interactive interface of the controlled terminal to the control terminal;
the control terminal is configured to display a second interactive interface matching the first interactive interface;
the control terminal is configured to receive a touch operation performed by a user on the second interactive interface;
the control terminal is configured to transmit the touch operation to the control center;
the control center is configured to control the controlled terminal to perform a touch response according to the touch operation;
the controlled terminal is configured to transmit the first touch response interface to the control center;
the control center is configured to forward the first touch response interface of the controlled terminal to the control terminal;
the control terminal is configured to display a second touch response interface matching the first touch response interface.

A terminal is provided, including: a wireless communication interface, a touch display screen and a processor;
in which the wireless communication interface is configured to establish a connection with a controlled terminal through a wireless communication manner;
the touch display screen is configured to display a second interactive interface, the second interactive interface matching the first interactive interface of the controlled terminal;
the touch display screen is configured to receive a touch operation performed by a user on the second interactive interface;
the processor is configured to control the controlled terminal to perform a touch response according to the touch operation, to display a first touch response interface;
the touch display screen is configured to display a second touch response interface, the second touch response interface matching the first touch response interface.

A terminal control apparatus is provided, including:
a connection establishment module, configured to establish a connection with a controlled terminal;
a first acquisition module configured to acquire a first interactive interface of the controlled) terminal;
a first display module configured to display a second interactive interface, the second interactive interface matching the first interactive interface of the controlled terminal;
a receiving module configured to receive a touch operation performed by a user on the second interactive interface;
a control module configured to control the controlled terminal to perform a touch response according to the touch operation;
a second acquisition module configured to acquire a first touch response interface of the controlled terminal, the first touch response interface is an interface displayed after the controlled terminal performs the touch response;
a second display module configured to display a second touch response interface, the second touch response interface matching the first touch response interface of the controlled terminal.

A terminal control apparatus is provided, including:
a connection establishment module configured to establish a connection with a control center, in which the connection is established between the control center and a controlled terminal;
a first acquisition module configured to acquire a first interactive interface of the controlled terminal through the control center;
a first display module configured to display a second interactive interface, the second interactive interface matching the first interactive interface of the controlled terminal;
a receiving module configured to receive a touch operation performed by a user on the second interactive interface;
a control module configured to transmit the touch operation to the control center, in which the control center is configured to control the controlled terminal to perform a touch response according to the touch operation;
a second acquisition module configured to acquire a first touch response interface of the controlled terminal through the control center, in which the first touch response interface is an interface displayed after the control led terminal performs the touch response;
a second display module configured to display a second touch response interface, the second touch response interface matching the first touch response interface of the controlled terminal.

A computer device is provided, including a memory, a processor, and a computer program stored in the memory and executed on the processor, in which the processor, when executing the computer program, implements the above-mentioned terminal control method.

A computer-readable storage medium is provided, on which a computer program is stored, when the computer program is executed by a processor, the above-mentioned terminal control method is implemented.

In the above-mentioned terminal control method, system and apparatus, computer device and storage medium, the connection between the control terminal and the controlled terminal is established; the control terminal acquires the first interactive interface of the controlled terminal, and displays the second interactive interface according to the first interactive interface. Since the second interactive interface matches the first interactive interface, information of the first interactive interface can be completely displayed; and the touch operation on the second interactive interface is equivalent to the touch operation on the first interactive interface. After the controlled terminal performs the touch response according to the touch operation, the second touch response interface matching the touch response of the controlled terminal is displayed on the control terminal, so that the result of the touch response of the controlled terminal can be completely displayed. In such method, the interaction between the control terminal and the controlled terminal replaces the direct operation on the control terminal, thereby avoiding a complex data processing process performed on the control terminal, reducing the storage space of the control terminal and the weights and volumes of the data processing module, and solving the problems of larger weight and volume, and dissatisfied portability of the terminal in the conventional communication system.

### BRIEF DESCRIPTION OF THE DRAWINGS

FIG. 1 is a flow chart showing a terminal control method according to an embodiment.

FIG. 2 is an application environment diagram for a terminal control method according to an embodiment.

FIG. 3 is a schematic diagram of controlling a controlled terminal to perform a touch response according to an embodiment.

FIG. 4 is a schematic diagram of displaying a second touch response interface according to an embodiment.

FIG. 5 is a flow chart showing a terminal control method according to another embodiment.

FIG. 6 is an application environment diagram for a terminal control method according to another embodiment.

FIG. 7 is a schematic diagram of a software architecture for a terminal control method according to an embodiment.

FIG. 8 is a schematic diagram of controlling a controlled terminal by a control center to perform a touch response according to an embodiment.

FIG. 9 is a schematic diagram of displaying a second touch response interface through a control center according to an embodiment.

FIG. 10 is a flow chart showing a terminal control method according to an embodiment.

FIG. 11 is a flow chart showing a terminal control method according to an embodiment.

FIG. 12 is a schematic diagram illustrating a terminal control system according to an embodiment.

FIG. 13 is a sequence diagram of a terminal control process according to an embodiment.

FIG. 14 is a schematic diagram illustrating a terminal control system according to an embodiment.

FIG. 15 is a sequence diagram of a terminal control process according to another embodiment.

FIG. 16 is a product structure diagram of a control terminal according to an embodiment.

FIG. 17 is a structure block diagram of a terminal control apparatus according to an embodiment.

FIG. 18 is a structure block diagram of a terminal control apparatus according to another embodiment.

### DETAILED DESCRIPTION

In order to make the purpose, the technical solution and advantages of the present disclosure clearer, the present disclosure will be further detailed with reference to the accompanying drawings and embodiments. It should be appreciated that specific embodiments described here are merely used for explaining the present disclosure, rather than limiting the present disclosure.

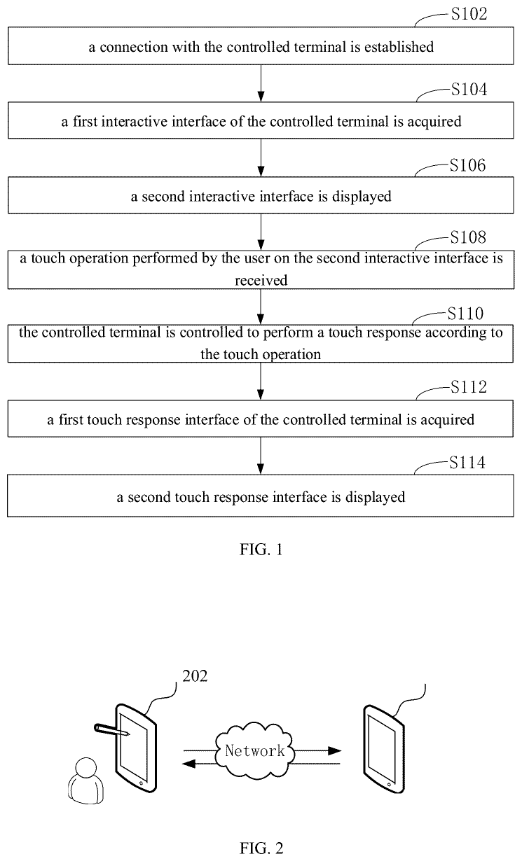

In an embodiment, as shown in FIG. 1, a terminal control method is provided. The terminal control method provided in this embodiment can be applied to an application environment shown in FIG. 2. In this application environment, a control terminal 202 and a controlled terminal 204 are included.

The control terminal 202 has touch and display functions. The touch function refers to that a user controls an operation interface by touching or writing with a writing pen on a touch screen. The display function includes displaying of the operation interface and a touch response interface. The touch response interface refers to an interface displaying a corresponding touch response after a touch operation.

The controlled terminal 204 is a terminal controlled by the control terminal 202. The controlled terminal 204 transmits an operation interface to the control terminal 202 through a wireless link to perform a touch response for a touch operation of the control terminal 202, and transmits the touch response interface to the control terminal 202 through the wireless link.

The above-mentioned terminal control method is described by applying to the control terminal 202 in FIG. 2 as an example, and may include following steps.

S102: a connection with the controlled terminal is established.

In a specific implementation, the control terminal 202 is assigned with an identity code in advance; the identity code is configured to distinguish different control terminals 202. Both the control terminal 202 and the controlled terminal 204 are installed with specific software for establishing a connection therebetween. The control terminal 202 transmits its own identity code to the controlled terminal 204 through Wi-Fi, Bluetooth or a custom wireless protocol; and the controlled terminal 204 reads the identity code, records the identity code in a data table, and then establishes a connection with the control terminal 202.

For example, the control terminal 202 transmits the identity code “001” to the controlled terminal 204; the controlled terminal 204 reads the identity code and records “001” in the data table. Accordingly, it can be seen that a connection is established between the controlled terminal 204 and a control terminal with the identity code “001” after the connection is established between the control terminal 202 and the controlled terminal 204.

S104: a first interactive interface of the controlled terminal is acquired.

The first interactive interface is an operation interface displayed on the controlled terminal 204.

In a specific implementation, an image of the operation interface of the controlled terminal 204 can be intercepted and can serve as the first interactive interface; or screen User Interface (UI) data, a screen size, a resolution, etc., of the controlled terminal 204 can be intercepted, and the first interactive interface is obtained according to these data.

For example, a screenshot operation can be performed on the entire operation interface of the controlled terminal 204, and a screenshot result can serve as the first interactive interface. Alternatively, parameters of the operation interface of the controlled terminal 204 are read to obtain a resolution of 2048/1536 pixels. When an upper left corner of the operation interface is the origin of coordinates, a software icon (for example, the WeChat icon) is located at coordinates (1600, 600) pixels. The first interactive interface can be obtained according to the resolution, an icon type, and an icon position.

S106: a second interactive interface is displayed.

The second interactive interface is the first interactive interface displayed according to the interface of the control terminal 202, that is, the second interactive interface matches the first interactive interface of the controlled terminal 204.

In a specific implementation, data such as the screen UI data, the screen size, and the resolution of the first interactive interface can be packaged in a communication protocol and transmitted to the control terminal 202. The data of the first interactive interface is proportionally scaled according to the resolution of the interface of the control terminal 202 to obtain the second interactive interface. When the resolution of the interface of the control terminal 202 is not proportional to the resolution of the first interactive interface, the first interactive interface can be proportionally scaled firstly, and then operations such as interception or filling are performed according to the scaling result to obtain the second interactive interface; and the second interactive interface is displayed.

For example, the resolution of the first interactive interface is 2048×1536 pixels, if the resolution of the interface of the control terminal 202 is 1024×768 pixels, the first interactive interface can be proportionally scaled down to 50% of the original size to obtain the second interactive interface. If the resolution of the interface of the control terminal 202 is 1024×800 pixels, the first interactive interface can be proportionally scaled down to 50% of the original size firstly, and is displayed at a center of the interface of the control terminal 202, and then the blank portion is filled with black to obtain the second interactive interface.

S108: a touch operation performed by the user on the second interactive interface is received.

The touch operation is an operation in which the user controls the operation interface by touching or writing with a writing pen on the second interactive interface.

In a specific implementation, the user can click the software icon on the second interactive interface with a finger or a writing pen to start up the software. Various controls in the software are clicked after the software is started up; or the touch operation is performed by writing on the operation interface after the software is started up.

For example, there is a WeChat icon at a position in the second interactive interface with coordinates of (1600, 600) pixels. The user can click the WeChat icon, and click various controls in the started WeChat, or enter text in a WeChat dialog box. After the above-mentioned touch operation is performed, the control terminal 202 receives the above-mentioned touch operation.

S110: the controlled terminal is controlled to perform a touch response according to the touch operation.

The touch response is a response provided by the controlled terminal 204 according to the touch operation.

In a specific implementation, after obtaining the touch operation, the control terminal 202 extracts data of the touch operation from the touch operation, and then can process the data of the touch operation according to the proportion between the first interactive interface and the second interactive interface, and then transmit the processed data of the touch operation to the controlled terminal 204. The controlled terminal 204 performs a touch response according to the processed data of the touch operation. The touch response includes information such as the screen ISI data, sound and son on after the response.

FIG. 3 is a schematic diagram of controlling a controlled terminal to perform a touch response according to an embodiment. The figure includes a smart tablet 302 and a tablet computer 304. The smart tablet 302 is a control terminal, while the tablet computer 304 is a controlled terminal. Referring to FIG. 3, the resolution of the first interactive interface of the tablet computer 304 is 2048×1536 pixels; and the resolution of the second interactive interface of the smart tablet 302 is 1024×768 pixels. When needing to start up the WeChat, the user clicks the WeChat icon at the position on the second interactive interface with the coordinates (800, 300). The data of the touch operation is transformed into a click operation at a position on the first interactive interface with the coordinates (1600, 600) according to the proportion between the first interactive interface and the second interactive interface, and then the data of the touch operation is transmitted to the tablet computer 304 through the network; the tablet computer 304 provides a touch response at the position on the first interactive interface with the coordinates (1600, 600).

S112: a first touch response interface of the controlled terminal is acquired.

The first touch response interface is an interface displayed after the controlled terminal 204 provides a touch response.

In a specific implementation, an image of the touch response interface of the controlled terminal 204 can be intercepted, and the image of the touch response interface can serve as the first touch response interface. Alternatively, information such as the resolution, color, and text of the touch response interface of the controlled terminal 204 is read, and the first touch response interface is obtained according to the information.

For example, a screenshot operation can be performed on the entire touch response interface of the controlled terminal 204, and a screenshot result can serve as the first touch response interface. Alternatively, information of the touch response interface of the controlled terminal 204 is read; the information includes the resolution of 2048×1536 pixels, a text content and position displayed by the touch response, an image color and position displayed by the touch response, etc.; and the first touch response interface is obtained according to the information of the touch response interface.

S114: a second touch response interface is displayed.

The second touch response interface is an interface matching the first touch response interface of the controlled terminal 204.

In a specific implementation, the first touch response interface can be proportionally scaled according to the resolution of the interface of the control terminal 202 to obtain the second touch response interface. When the resolution of the interface of the control terminal 202 is not proportional to the resolution of the first touch response interface, the first touch response interface can be proportionally scaled, and then operations such as interception or filling are performed according to the scaling result to obtain the second touch response interface; and the second touch response interface is displayed.

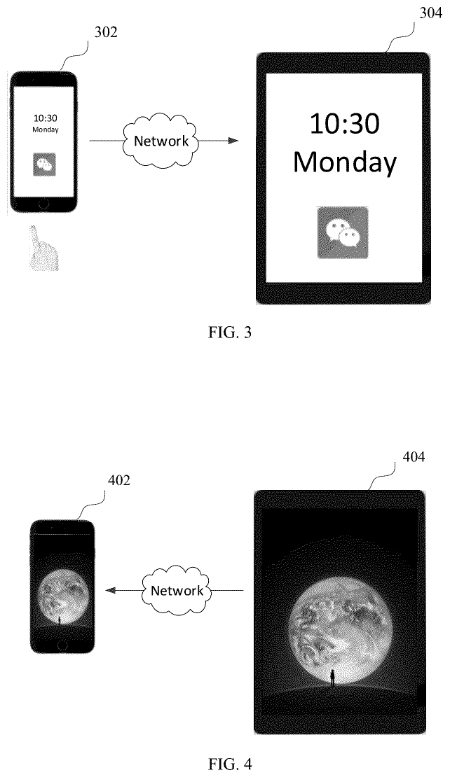

FIG. 4 is a schematic diagram of displaying a second touch response interface according to an embodiment. The figure includes a smart tablet 402 and a tablet computer 404; the smart tablet 402 is a control terminal, and the tablet computer 404 is a controlled terminal, Referring to FIG. 4, after receiving the WeChat startup operation, the tablet computer 404 provides a touch response to obtain the WeChat startup interface, that is, the first touch response interface of the controlled terminal. The first touch response interface is transmitted to the smart tablet 402 through the network. The resolution of the first touch response interface is 2048×1536 pixels. If the resolution of the interface of the smart tablet 402 is 1024×768 pixels, the first touch response interface can be proportionally scaled down to 50% of the original size to obtain the second touch response interface. If the resolution of the interface of the smart tablet 402 is 700×384 pixels, the first touch response interface can be proportionally scaled down to 50% of the original size firstly and displayed in at the center position of the interface of the smart tablet 402; and then a portion which is not displayed is filled with black to obtain the second touch response interface. After that, the smart tablet 402 displays the second touch response interface.

In the above-mentioned terminal control method, a connection between the control terminal and the controlled terminal is established, the control terminal acquires the first interactive interface of the controlled terminal, and displays the second interactive interface according to the first interactive interface. Since the second interactive interface matches the first interactive interface, the information of the first interactive interface can be comprehensively displayed; and the touch operation on the second interactive interface is equivalent to the touch operation on the first interactive interface. After the controlled terminal provides the touch response according to the touch operation, the second touch response interface matching the touch response of the controlled terminal is displayed on the control terminal, accordingly the result of the touch response of the controlled terminal can be comprehensively displayed. In this method, the direct operation of the control terminal is replaced with an interaction between the control terminal and the controlled terminal, thereby avoiding a complex data processing process performed on the control terminal, reducing the storage space of the control terminal and the weights and volumes of the data processing module, and solving the problems of larger weight and volume, and dissatisfied portability of the terminal in the conventional communication system.

In an embodiment, the above step S110 may specifically include:
data of the touch operation is obtained according to the touch operation; data of a touch operation of the controlled terminal is obtained according to the data of the touch operation; the data of the touch operation data of the controlled terminal is transmitted to the controlled terminal for the controlled terminal to provide the touch response according to the data of the touch operation of the controlled terminal, to obtain a first touch response interface of the controlled terminal.

The touch operation data is data of the touch operation performed by the user on the control terminal 202, which includes data such as a position, time, etc., of the touch operation.

The touch operation data of the controlled terminal is the touch operation data for the controlled terminal 204 obtained by processing the touch operation data.

In a specific implementation, after obtaining the touch operation, the control terminal 202 extracts the touch operation data from the touch operation, and then can process the touch operation data according to the proportion between the first interactive interface and the second interactive interface to obtain the touch operation data of the controlled terminal, and transmits the touch operation data of the controlled terminal to the controlled terminal 204; and the controlled terminal 204 performs a touch response according to the touch operation data of the controlled terminal. Since the procedure of the step S110 is described in detail in the foregoing embodiments, it will not be repeated here.

In the above terminal control method, the control terminal obtains the touch operation data according to the touch operation, and transforms the touch operation data to obtain the touch operation data of the controlled terminal for the first interactive interface of the controlled terminal. Since the touch operation data of the controlled terminal is obtained by transforming the touch operation data of the controlled terminal, the touch operation data of the control terminal matches the touch operation data of the controlled terminal, the touch operation can be accurately implemented on the controlled terminal. The controlled terminal performs a touch response according to the touch operation data of the controlled terminal, and obtains the first touch response interface. Since the first touch response interface matches the second touch response interface of the control terminal, the control terminal can obtain the touch response information without needing to perform a complicated operation, thereby reducing the weights and volumes of the storage space and the data processing modules of the control terminal, and then solving the problems of larger weight and volume, and dissatisfied portability of the terminal in the conventional communication system.

In an embodiment, the above step S102 may specifically include: a connection with the controlled terminal is established through Wi-Fi, Bluetooth or a custom wireless protocol.

In a specific implementation, a communication distance between the control terminal 202 and the controlled terminal 204 is within a communication range of the Wi-Fi or Bluetooth, and the data transmission therebetween is implemented through the W-E, Bluetooth or a custom wireless protocol.

Since a general platform such as Wi-Fi or Bluetooth is used, or a custom wireless protocol is used in the above-mentioned method, a completely open operating environment can be maintained, which allows any controlled terminal to develop application software at any time, and can meet the increasingly complex and diverse functional requirements of the communication products.

In an embodiment, the above step S102 may further include: an identity code is acquired; the identity code is transmitted to the controlled terminal, for establishing the connection by the controlled terminal after successfully verifying the identity code.

The identity code is identity information of the control terminal 202.

In the specific implementation, the control terminal 202 is assigned with an identity code in advance. After acquiring its own identity code, the control terminal 202 transmits the identity code to the controlled terminal 204 through the Wi-Fi, Bluetooth or a custom wireless protocol; the controlled terminal 204 reads and verifies the identity code, and records the identity code in a data table when the verification passes, and establishes a connection with the control terminal 202.

For example, the control terminal 202 transmits the identity code “001” to the controlled terminal 204, and the controlled terminal 204 reads and verifies the identity code, and records “001” in the data table when the verification result is a permission to establish a connection, and establishes the connection with the control terminal 202.

After the identity code of the control terminal 202 is acquired in the above method, a connection between the control terminal 202 and the controlled terminal 204 is established according to the identity code, which can ensure the reliability of the connection establishment and improve the accuracy of subsequent data transmission.

In an embodiment, the above step S104 may specifically include: interactive interface screenshot data is acquired; the interactive interface screenshot data is processed to obtain processed interactive interface screenshot data.

The interactive interface screenshot data is data obtained by performing screenshot of the first interactive interface of the controlled terminal 204.

The processed interactive interface screenshot data is screenshot data obtained by processing the interactive interface screenshot data and configured to display the second interactive interface.

In a specific implementation, the control terminal 202 can intercept an operation interface image of the controlled terminal 204 to obtain the interactive interface screenshot data; and the screen UI data, the screen size, the resolution, etc., can be obtained from the interactive interface screenshot data. After that, the interactive interface screenshot data is processed by scaling, intercepting or filling, etc., according to the sizes of the first interactive interface and the second interactive interface, to obtain the processed interactive interface screenshot data; and the second interactive interface can be displayed according to the processed interactive interface screenshot data. Since the procedure of the step S104 is described in detail in the foregoing embodiment, it will not be repeated here.

After the interactive interface screenshot data is acquired in the above method, the interactive interface screenshot data is processed, such that the displayed second interactive interface matches the first interactive interface; the information of the first interactive interface can be completely displayed; the touch operation on the second interactive interface is equivalent to the touch operation on the first interactive interface, which avoids the complicated data processing procedure performed on the control terminal, and reduces the weights and volumes of the storage space and the data processing module of the control terminal, and solves the problems of larger weight and volume, and dissatisfied portability of the terminal in the conventional communication system.

In an embodiment, the above step S112 may specifically include: response interface screenshot data is acquired; and the response interface screenshot data is processed to obtain processed response interface screenshot data.

The response interface screenshot data is data obtained by performing screenshot of the first touch response interface of the controlled terminal 204.

The processed response interface screenshot data is screenshot data obtained by processing the response interface screenshot data and configured to display the second touch response interface.

In a specific implementation, the control terminal 202 can intercept an image of the first touch response interface of the controlled terminal 204 to obtain the response interface screenshot data, and then obtain the screen UI data, the screen size, the resolution, etc., from the response interface screen shot data. After that, the response interface screenshot data is processed by scaling, intercepting or filling, etc., according to the sizes of the first touch response interface and the second touch response interface, to obtain the processed response interface screenshot data; and the second touch response interface can be displayed according to the processed response interface screenshot data. Since the procedure of the step S112 is described in detail in the foregoing embodiment, it will not be repeated here.

After the response interface screenshot data is acquired in the above method, the response interface screenshot data is processed, such that the displayed second touch response interface matches the first touch response interface, and the information of the first touch response interface can be completely displayed; the touch operation on the second touch response interface is equivalent to the touch operation on the first touch response interface, which avoids performing complex data processing procedures on the control terminal, and reduces the weights and volumes of the storage space and the data processing module of the control terminal, and solves the problems of larger weight and volume, and dissatisfied portability of the terminal in the conventional communication system.

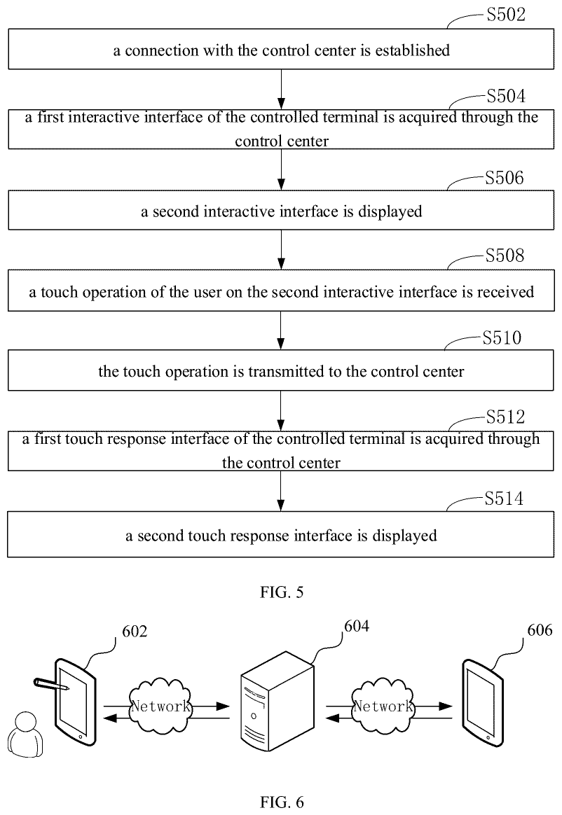

In an embodiment, as shown in FIG. 5, another terminal control method is provided. The terminal control method provided in this embodiment can be applied to the application environment shown in FIG. 6. In this application environment, a control terminal 602, a control center 604 and a controlled terminal 606 are included.

The control center is configured to forward data between the control terminal and the controlled terminal, which may be a cloud computing server or the like.

Referring to FIG. 5, the terminal control method specifically includes the following steps.
S502: a connection with the control center is established.
S504: a first interactive interface of the controlled terminal is acquired through the control center.
S506: a second interactive interface is displayed.
S508: a touch operation of the user on the second interactive interface is received.
S510: the touch operation is transmitted to the control center.
S512: a first touch response interface of the controlled terminal is acquired through the control center.
S514: a second touch response interface is displayed.

In the specific implementation, the controlled terminal 606 establishes a connection with the control center 604 in advance. The controlled terminal 606 can back up data in the control center 604 in advance, and set the data to an accessible state, or, set the controlled terminal 606 in a controllable state through pre-installed software. The control terminal 602 transmits its own identity code to the control center 604, and the control center 604 establishes a connection with the control terminal 602 after receiving the identity code. The control terminal 602 acquires the first interactive interface of the controlled terminal 606 through the control center 604, and obtains the second interactive interface after processing the first interactive interface, and displays the second interactive interface. The user performs a touch operation on the second interactive interface, and the control terminal 602 is pre-set with software, such as a browser access, etc., for receiving the touch operation of the user. The control terminal 602 receives the touch operation, collects and processes touch operation data, and forwards the processed touch operation data to the controlled terminal 606 through the control center 604. The controlled terminal 606 responds to the touch operation to obtain the first touch response interface, and transmits data of the first touch response interface to the control terminal 602 through the control center 604. The control terminal 602 obtains a second touch response after processing the first touch response interface, and displays the second touch response.

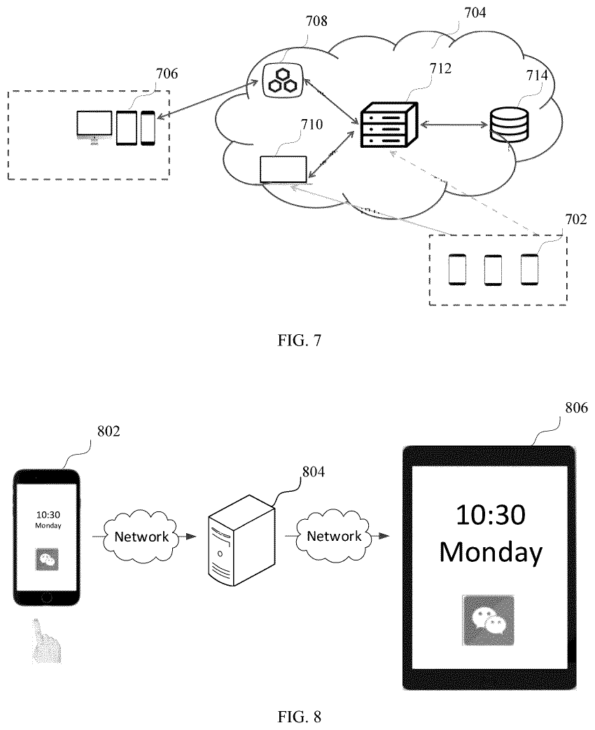

FIG. 7 is a schematic diagram of a software architecture of a terminal control method according to an embodiment, in which a smart tablet 702, a cloud computing server 704 and a tablet computer 706; the smart tablet 702 is a control terminal, the cloud computing server 704 is a control center, and the tablet computer 706 is a controlled terminal. The cloud computing server 704 includes a message middleware 708, a front end 710, a back end 712 and a database 714.

Referring to FIG. 7, the tablet computer 706 executes software of data such as the block screen UI and touch event, etc., and establishes a connection with the cloud computing server 704 via the 4G/5G network, carrying private protocol data through the TCP/IP protocol. In the cloud computing server 704, the message middleware 708 distributes data efficiently; the back end 712 and the front end 710 perform bidirectional communication through the Websocket protocol; on the tablet computer 706 side, the cloud computing server 704 efficiently transmits the interactive interface screenshot data or the touch response interface screenshot data to render the front end 710; on the smart tablet 702 side, the cloud computing server 704 efficiently receives the request of the smart tablet 702 and receives the touch operation data of the front end 710, and transmits it to the message middleware 708 through TCP/IP; and the message middleware 708 efficiently distributes the data and encapsulates the data by the TCP/IP protocol carrying the private protocol before forwarding to the tablet computer 706. The smart tablet 702 accesses web services provided by the front end 710 and the back end 712 through HTTP or REpresentational State Transfer (RESTful) interface, and can operate the tablet computer 706 and efficiently forward the touch operation data to the tablet computer 706 through the cloud computing server 704, thereby implementing networking of operations and computations.

FIG. 8 is a schematic diagram of controlling a controlled terminal by a control center to perform a touch response according to an embodiment, which includes a smart tablet 802, a cloud computing server 804 and a tablet computer 806. Referring to FIG. 8, the resolution of the first interactive interface of the tablet computer 806 is 2048×1536 pixels, and the resolution of the second interactive interface of the smart tablet 802 is 1024×768 pixels. When the user needs to start up the WeChat, a WeChat icon with coordinates (800, 300) on the second interactive interface is clicked, the touch operation data is transformed into a click operation at a position with coordinates 1600, 600)) on the first interactive interface according to the proportion between the first interactive interface and the second interactive interface; and then the touch operation data is transmitted to the tablet computer 304 through the cloud computing server 804, and the tablet computer 304 performs a touch response at the position with the coordinates (1600, 600) on the first interactive interface.

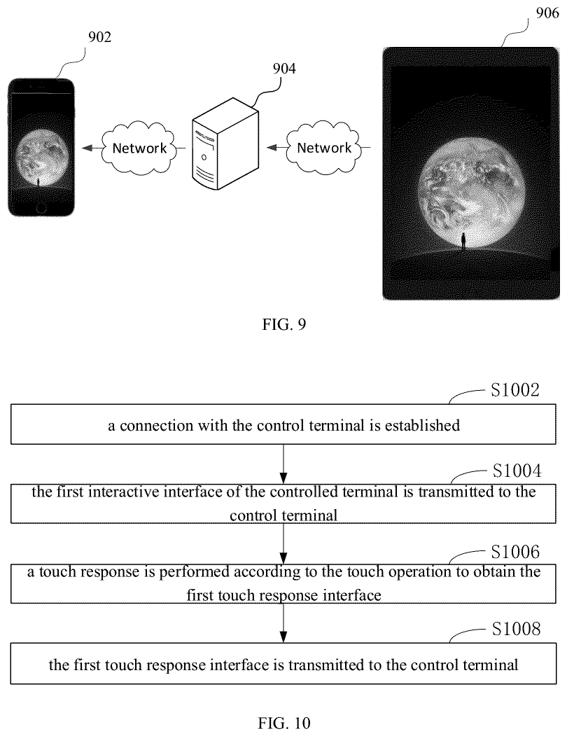

FIG. 9 is a schematic diagram of displaying a second touch response interface through a control center according to an embodiment, which includes a smart tablet 902, a cloud computing server 904 and a tablet computer 906. Referring to FIG. 9, through the cloud computing server 904, the tablet computer 906 performs a touch response after receiving the operation of starting up the WeChat to obtain a WeChat startup interface, that is, the first touch response interface of the controlled terminal. The tablet computer 906 transmits the first touch response interface to the smart tablet 902 through the cloud computing server 904. The resolution of the first touch response interface is 2048×1536 pixels. If the resolution of the interface of the smart tablet 902 is 1024×768 pixels, the first touch response interface can be proportionally scaled down to 50% of the original to obtain the second touch response Interface; if the resolution of the interface of the smart tablet 902 is 700×384 pixels, the first touch response interface can be proportionally scaled down to 50% of the original to display at the center of the interface of the smart tablet 902 with a portion, which is not displayed, filled with black to obtain the second touch response interface. After that, the smart tablet 902 displays the second touch response interface.

In the above terminal control method, connections are established among the control terminal, the control center and the controlled terminal; and the control terminal obtains the first interactive interface of the controlled terminal through the forwarding of the control center, and displays the second interactive interface according to the first interactive interface. Since the second interactive interface matches the first interactive interface, the information of the first interactive interface can be completely displayed; the touch operation performed on the second interactive interface is equivalent to the touch operation performed on the first interactive interface. The touch operation data is forwarded through the control center; and after the controlled terminal performs the touch response according to the touch operation, the second touch response interface matching the touch response of the controlled terminal is displayed on the control terminal, which can completely display the result of the touch response of the controlled terminal. In the method, the control terminal interacts with the controlled terminal through the control center, instead of directly operating the control terminal, thereby avoiding performing complex data processing procedures on the control terminal, and solving the problems of larger weight and volume, and dissatisfied portability of the terminal in the conventional communication system. Further, through the forwarding of the control center, the requirements of long-distance communication can be satisfied. Further, the future development prospects of the communication system can be maximized, and complex problems caused by existing terminal brands and operator configuration thresholds can be reduced.

In an embodiment, the above step S502 may specifically include: a connection with the control center is established through a 3G/4G/5G network or

In a specific implementation, a communication distance between the control terminal 602 and the control center 604 may be within a communication range of the Wi-Fi, or within a communication range of the 3G/4G/5G network; and the data transmission between the control terminal 602 and the control center 604 can be implemented through the 3G/4G/5G network or Wi-Fi.

The above method not only uses the Wi-Fi universal platform, which allows any controlled terminal to develop application software at any time, but also uses a wireless communication network such as the 3G/4G/5G network, which can ensure the quality of communication in the case of long transmission distances and further satisfy the increasingly complex and diverse functional requirements of communication products:

In an embodiment, the above step S502 may further include: an identity code is acquired; the identity code is transmitted to the control center, and the identity code is forwarded to the controlled terminal by the control center, for establishing the connection by the controlled terminal after successfully verifying the identity code.

In a specific implementation, the control terminal 602 is assigned with an identity code in advance. After obtaining its own identity code, the control terminal 602 transmits the identity code to the controlled terminal 606 through the control center 604 via the 3G/4G/5G network or The controlled terminal 606 reads and verifies the identity code, and records the identity code in the data table when the verification passes, and establishes a connection with the control terminal 602 through the control center 604. Since the procedure of the step S502 is described in detail in the foregoing embodiment, it will not be repeated here.

After the identity code of the control terminal 602 is acquired in the above method, a connection between the control terminal 602 and the controlled terminal 606 is established through the control center 604 according to the identity code, which can ensure the reliability of the connection establishment and improve the accuracy of subsequent transmission of the data.

In an embodiment, the above step S504 may specifically include: a manipulation request of the controlled terminal is received; and the control center is accessed according to the manipulation request of the controlled terminal to obtain the first interactive interface of the controlled terminal.

The manipulation request of the controlled terminal is a manipulation request for the controlled terminal 606 from the user.

In a specific implementation, when the user requests to manipulate the controlled terminal 606, the control terminal 602 receives the manipulation request of the controlled terminal from the user, and the control terminal 602 accesses the control center 604 according to the manipulation request of the controlled terminal, to obtain the first interactive interface of the controlled terminal. The first interactive interface of the controlled terminal may be controlled terminal data pre-stored in the control center 604, or controlled terminal data Obtained by accessing interface data between the control terminal 602 and the control center 604. Since the procedure of the step S504 is described in detail in the foregoing embodiment, it will not be repeated here.

In the above method, the control center is accessed according to the manipulation request of the controlled terminal, which can avoid performing complex data processing procedures on the control terminal, and reduce the weights and volumes of the storage space and the data processing module of the control terminal, and solve the problems of larger weight and volume, and dissatisfied portability of the terminal in the conventional communication system.

In an embodiment, the above step S504 may further include: interactive interface screenshot data is acquired through the control center; and the interactive interface screenshot data is processed to obtain processed interactive interface screenshot data.

In a specific implementation, the control terminal 602 intercepts an image of the operation interface of the controlled terminal 606 through the control center 604, to obtain the interactive interface screenshot data. The interactive interface screenshot data is processed by scaling, intercepting or filling, etc., according to the sizes of the first interactive interface and the second interactive interface, to obtain the processed interactive interface screenshot data; and the second interactive interface can be displayed according to the processed interactive interface screenshot data. Since the procedure of the step S504 is described in detail in the foregoing embodiment, it will not be repeated here.

After the interactive interface screenshot data is acquired in the above method, the interactive interface screenshot data is processed. Since the second interactive interface matches the first interactive interface, the first interactive interface can be controlled by touching the second interactive interface, thereby avoiding complex data processing procedures performed on the control terminal, and reducing the weights and volumes of the storage space and the data processing module of the control terminal, and solving the problems of larger weight and volume, and dissatisfied portability of the terminal in the conventional communication system.

In an embodiment, the above step S512 may specifically include: the response interface screenshot data is acquired through the control center; and the response interface screenshot data is processed to obtain the processed response interface screenshot data.

In a specific implementation, the control terminal 602 can intercept an image of the first touch response interface of the controlled terminal 606 through the control center 604 to obtain response interface screenshot data. According to the sizes of the first touch response interface and the second touch response interface, the response interface screenshot data is processed by scaling, intercepting or filling, etc., to obtain the processed response interface screenshot data; and the second touch response interface can be displayed according to the processed response interface screenshot data. Since the procedure of the step S512 is described in detail in the foregoing embodiment, it will not be repeated here.

After the response interface screenshot data is acquired in the above method, the response interface screenshot data is processed. Since the second touch response interface matches the first touch response interface, the first touch response interface can be controlled by touching the second touch response interface, thereby avoiding complex data processing procedures performed on the control terminal, and reducing the weights and volumes of the storage space and the data processing module of the control terminal, and solving the problems of larger weight and volume, and dissatisfied portability of the terminal in the conventional communication system.

As shown in FIG. 10, in an embodiment, the controlled terminal 204 applied in FIG. 2 is taken as an example for description, the method may include the following steps.
S1002: a connection with the control terminal is established.
S1004: the first interactive interface of the controlled terminal is transmitted to the control terminal.
S1006: a touch response is performed according to the touch operation to obtain the first touch response interface.
S1008: the first touch response interface is transmitted to the control terminal.

In a specific implementation, after the connection with the control terminal 202 is established, the controlled terminal 204 obtains the first interactive interface and transmits the first interactive interface to the control terminal 202. The user performs a touch operation on the control terminal 202; and the control terminal 202 processes the touch operation before transmitting the processed touch operation to the controlled terminal 204; the controlled terminal 204 performs a touch response according to the touch operation to obtain the first touch response interface, and then transmits the first touch response interface to the control terminal 202. Since the procedure of the above method is described in detail in the foregoing embodiment, it will not be repeated here.

In the above method, the first interactive interface of the controlled terminal is transmitted to the control terminal by establishing the connection between the control terminal and the controlled terminal. Since the second interactive interface obtained by the control terminal can completely display the information of the first interactive interface, the controlled terminal performs the touch response according to the touch operation, and the first touch response interface transmitted to the control terminal can completely display the result of the touch response of the controlled terminal. In the method, the interaction between the control terminal and the controlled terminal replaces the direct operation of the control terminal, which avoids complex data processing procedures performed on the control terminal, and reduces the weights and volumes of the storage space and the data processing module of the control terminal, and solves the problems of larger weight and volume, and dissatisfied portability of the terminal in the conventional communication system.

In an embodiment, the above step S1004 may specifically include: screenshot of the first interactive interface of the controlled terminal is performed to obtain interactive interface screenshot data; and the interactive interface screenshot data is transmitted to the control terminal.

In a specific implementation, the controlled terminal 204 acquires the screenshot of the first interactive interface of the controlled terminal to obtain the interactive interface screenshot data; and the screen UI data, the screen size, the resolution, etc., can be obtained from the interactive interface screenshot data. Then, the controlled terminal 204 transmits the interactive interface screenshot data to the control terminal 202. Since the procedure of the above method is described in detail in the foregoing embodiment, it will not be repeated here.

In the above method, the screenshot of the first interactive interface of the controlled terminal is acquired, and the interactive interface screenshot data is transmitted to the control terminal, thereby avoiding complex data processing procedures performed on the control terminal, and reducing the weights and volumes of the storage space and the data processing module of the control terminal, and solving the problems of larger weight and volume, and dissatisfied portability of the terminal in the conventional communication system.

In an embodiment, the above step S1008 may specifically include: screenshot of the first touch response interface is performed to obtain response interface screenshot data; and the response interface screenshot data is transmitted to the control terminal.

In a specific implementation, the controlled terminal 204 performs screenshot of the first touch response interface of the controlled terminal to obtain response interface screenshot data; and the screen UI data, the screen size, the resolution, etc., can be obtained from the response interface screenshot data. After that, the controlled terminal 204 transmits the response interface screenshot data to the control terminal 202. Since the procedure of the above method is described in detail in the foregoing embodiment, it will not be repeated here.

In the above method, the screenshot of the first touch response interface of the controlled terminal is acquired, and the response interface screenshot data is transmitted to the control terminal, thereby avoiding complex data processing procedures performed on the control terminal, and reducing the weights and volumes of the storage space and the data processing module of the control terminal, and solving the problems of larger weight and volume, and dissatisfied portability of the terminal in the conventional communication system.

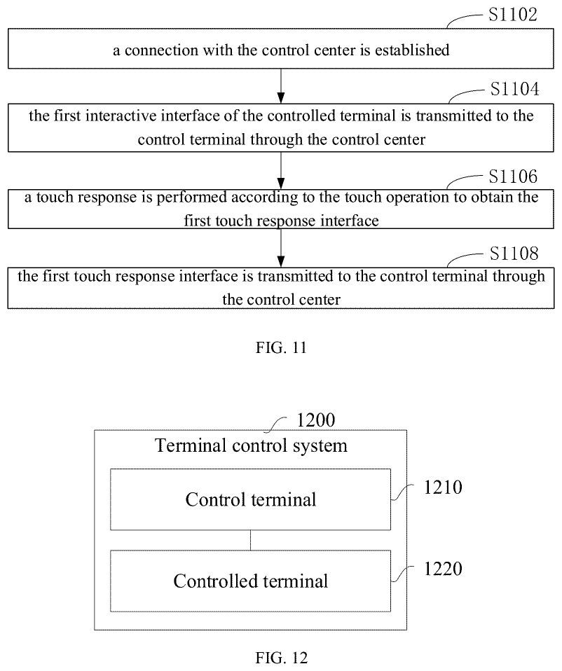

As shown in FIG. 11, in an embodiment, the controlled terminal 606 applied in FIG. 6 is taken as an example for description, and the method may include the following steps.

S1102: a connection with the control center is established; a connection between the control center and the control terminal is established.

S1104: the first interactive interface of the controlled terminal is transmitted to the control terminal through the control center.

S1106: a touch response is performed according to the touch operation to obtain the first touch response interface.

S1108: the first touch response interface is transmitted to the control terminal through the control center.

In a specific implementation, the controlled terminal 606 establishes a connection with the control center 604 in advance. When the control terminal 602 also establishes a connection with the control center 604, the controlled terminal 606 acquires the first interactive interface and transmits the first interactive interface to the control terminal 602 through the control center 604; the user performs a touch operation on the control terminal 602; the control terminal 602 processes the touch operation and transmits the processed touch operation to the controlled terminal 606; the controlled terminal 606 performs the touch response according to the touch operation to obtain the first touch response interface; after that, the first touch response interface is transmitted to the control terminal 602 through the control center 604. Since the procedure of the above method is described in detail in the foregoing embodiment, it will not be repeated here.

In the above method, the connection among the control terminal, the control center and the controlled terminal are established, the first interactive interface of the controlled terminal is transmitted to the control terminal through the control center. Since the second interactive interface obtained at the control terminal can completely display the information of the first interactive interface, the controlled terminal performs the touch response according to the touch operation, and the first touch response interface transmitted by the control center to the control terminal can completely display the result of the touch response of the controlled terminal. In the method, the interaction between the control terminal and the controlled terminal replaces the direct operation of the control terminal, thereby avoiding complex data processing procedures performed on the control terminal, and reducing the weights and volumes of the storage space and the data processing module of the control terminal, and solving the problems of larger weight and volume, and dissatisfied portability of the terminal in the conventional communication system. Further, through the forwarding of the control center, the requirements of a long-distance communication can be satisfied. Further, the future development prospects of the communication system can be maximized, and complex problems caused by the existing terminal brands and operator configuration thresholds can be reduced.

In an embodiment, the above step S1104 may specifically include: screenshot of the first interactive interface of the controlled terminal is performed to obtain interactive interface screenshot data; the interactive interface screenshot data is transmitted to the control terminal through the control center.

In a specific implementation, the controlled terminal 606 acquires the screenshot of the first interactive interface of the controlled terminal to obtain the interactive interface screenshot data; the screen UI data, the screen size, the resolution, etc., can be obtained from the interactive interface screenshot data. After that, the controlled terminal 606 transmits the interactive interface screenshot data to the control terminal 602 through the control center 604. Since the processing procedure of the above method is described in detail in the foregoing embodiment, it will not be repeated here.

In the above method, the screenshot of the first interactive interface of the controlled terminal is acquired, and the interactive interface screenshot data is transmitted to the control terminal through the control center, thereby avoiding complex data processing procedures performed on the control terminal, and reducing the weights and volumes of the storage space and the data processing module of the control terminal, and solving the problems of larger weight and volume, and dissatisfied portability of the terminal in the conventional communication system.

In an embodiment, the above step S1108 may specifically include: screenshot of the first touch response interface is performed to obtain response interface screenshot data; the response interface screenshot data is transmitted to the control terminal through the control center.

In a specific implementation, the controlled terminal 606 acquires the screenshot of the first touch response interface of the controlled terminal to obtain the response interface screenshot data; the screen UI data, the screen size, the resolution, etc., can be obtained from the response interface screenshot data. After that, the controlled terminal 606 transmits the response interface screenshot data to the control terminal 602 through the control center 604. Since the processing procedure of the above method is described in detail in the foregoing embodiment, it will not be repeated here.

In the above method, the screenshot of the first touch response interface of the controlled terminal is acquired, and the response interface screenshot data is transmitted to the control terminal through the control center, thereby avoiding complex data processing procedures performed on the control terminal, and reducing the weights and volumes of the storage space and the data processing module of the control terminal, and solving the problems of larger weight and volume, and dissatisfied portability of the terminal in the conventional communication system.

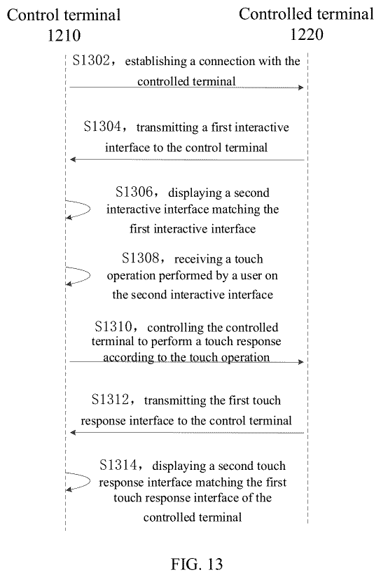

As shown in FIG. 12, in an embodiment, a terminal control system 1200 is provided, which includes a control terminal 1210 and a controlled terminal 1220. FIG. 13 is a sequence diagram of a terminal control procedure of the terminal control system 1200. Referring to FIG. 13, the terminal control procedure may include the following steps.

S1302: the control terminal 1210 establishes a connection with the controlled terminal 1220.

S1304: the controlled terminal 220 transmits a first interactive interface to the control terminal 1210.

S1306: control terminal 1210 displays a second interactive interface matching the first interactive interface.

S1308: the control terminal 1210 receives a touch operation performed by a user on the second interactive interface.

S1310: the control terminal 1210 controls the controlled terminal 1220 to perform a touch response according to the touch operation.

S1312: the controlled terminal 1220 transmits the first touch response interface to the control terminal 1210.

S1314: the control terminal 1210 displays a second touch response interface matching the first touch response interface of the controlled terminal 1220.

It should be appreciated that, although the steps in the above flowchart are displayed in sequence according to the arrows, these steps are not definitely executed in the sequence indicated by the arrows. Unless explicitly stated herein, the execution of these steps is not strictly limited to the order, and these steps may be performed in other orders. Moreover, at least a part of the steps in the above flowchart may include multiple sub-steps or multiple stages. These sub-steps or stages are not definitely executed at the same time, but may be executed at different time. These sub-steps or stages are not definitely executed sequentially, but may be performed in turns or alternately with other steps or at least a part of sub-steps or stages of other steps.

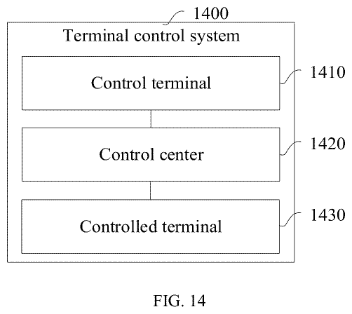

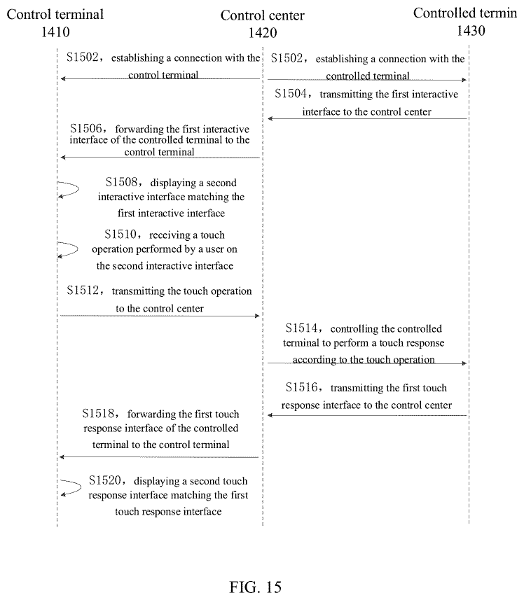

As shown in FIG. 14, in an embodiment, another terminal control system 1400 is provided, which includes a control terminal 1410, a control center 1420 and a controlled terminal 1430. FIG. 15 is a sequence diagram of a terminal control procedure of the terminal control system 1400. Referring to FIG. 15, the terminal control procedure may include the following steps.

S1502: the control center 1420 establishes a connection with the control terminal 1410, and is configured to establish a connection with the controlled terminal 1430.

S1504 the controlled terminal 1430 transmits the first interactive interface to the control center 1420.

S1506: the control center 1420 forwards the first interactive interface of the controlled terminal 1430 to the control terminal 1410.

S1508: the control terminal 1410 displays a second interactive interface matching the first interactive interface.

S1510: the control terminal 1410 receives a touch operation performed by a user on the second interactive interface.

S1512: the control terminal 1410 transmits the touch operation to the control center 1420.

S1514: the control center 1420 controls the controlled terminal 1430 to perform a touch response according to the touch operation.

S1516: the controlled terminal 1430 transmits the first touch response interface to the control center 1420.

S1518: the control center 1420 forwards the first touch response interface of the controlled terminal 1430 to the control terminal 1410.

S1520: the control terminal 1410 displays a second touch response interface matching the first touch response interface.

It should be appreciated that, although the steps in the above flowchart are displayed in sequence according to the arrows, these steps are not definitely executed in the sequence indicated by the arrows. Unless explicitly stated herein, the execution of these steps is not strictly limited to the order, and these steps may be performed in other orders. Moreover, at least a part of the steps in the above flowchart may include multiple sub-steps or multiple stages. These sub-steps or stages are not definitely executed at the same time, but may be executed at different time. These sub-steps or stages are not definitely executed sequentially, but may be performed in turns or alternately with other steps or at least a part of sub-steps or stages of other steps.

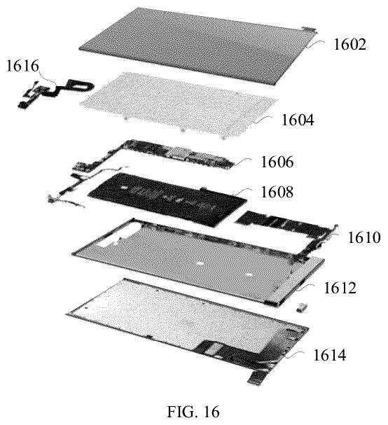

As shown in FIG. 16, in an embodiment, a terminal is provided, which is a control terminal, including:
a wireless communication interface 1616, configured to establish a connection with the controlled terminal through a wireless communication mode;
a touch display screen 1602, configured to display a second interactive interface;
a touch display screen 1602, configured to receive a touch operation performed by a user on the second interactive interface;
a processor 1606, configured to control the controlled terminal to perform a touch response according to the touch operation, to display a first touch response interface;
a touch display screen 1602, configured to display a second touch response interface.

Referring to FIG. 16, the wireless communication interface 1616 can be a 3G/4G/5G network or a Wi-Fi antenna interface; the touch display screen 1602 can be an Organic Light-Emitting Diode (OLED) and a glass (or sapphire) cover plate; the processor 1606 is equipped with a Qualcomm APQ8053 on a Printed. Circuit Board+Assembly (PCBA). In addition, the terminal further includes a separator 1604, a battery 1608 (with a capacity 1000 mAh, 1.0 mm), a USB interface 1610 (Type C), a stainless steel middle frame 1612 and a rear cover plate 1614; the rear cover plate 1614 can be the OLED and the glass (or sapphire).) cover plate. Since components such as microphones and cameras, etc., are not designed, a dialogue function can be implemented through a Bluetooth headset; and photography can be implemented by a watch.

A thickness of the terminal can be 4 mm. For tablet terminals such as network mobile phones, network video terminals, game terminals and various extensions (such as biological detection) of smart watches, five to six-inch screens can be utilized. For smart home terminals such as home management boards, reading boards, game boards, WeChat boards, social boards and homework boards, etc., seven to fourteen-inch screens can be utilized. For intelligent teaching, conference, aviation and high-speed rail terminals such as teaching boards, textbook boards, exam boards, conference boards, aviation boards, high-speed rail boards and one-way confidential information boards, etc., the seven to fourteen-inch screens can also be utilized. For smart surface terminals such as desk boards, projection display boards, ordering boards, bus stop boards, household appliance boards, smart furniture boards, bar interactive boards, outdoor natural scene film and television interactive boards and concerts competitive sports focus boards, etc., five to one hundred and five-inch screens can be utilized.

The above-mentioned terminal can ensure good implementation of touch and display functions, and implement functions such as data processing and storage, etc., through the controlled terminal and/or control center, and functionally separate the touch and display from other functions. Since there is no need to implement functions such as data processing and storage, etc., compared with conventional terminals, the above-mentioned terminal can implement various complex functions with lighter weight, smaller volume and thinner thickness, which solves the problems of larger weight and volume, and dissatisfied portability of the terminal in the conventional communication system.

Further, due to the use of an open communication platform, it is possible to communicate directly through an open platform such as a wireless communication network or cloud without relying on any mobile phone brand and without the operator's license, thereby avoiding the complex problems caused by the existing terminal brands and operator configuration thresholds.

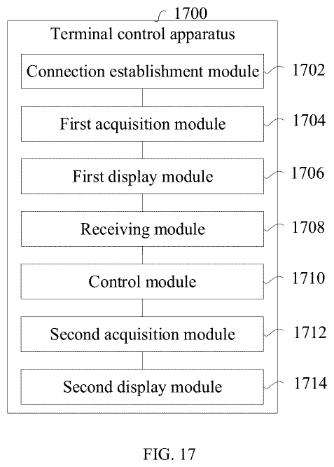

As shown in FIG. 17, in an embodiment, a terminal control apparatus is provided, including:
a connection establishment module 1702, configured to establish a connection with the controlled terminal;
a first acquisition module 1704, configured to acquire a first interactive interface of the controlled terminal;
a first display module 1706, configured to display a second interactive interface, in which the second interactive interface matches the first interactive interface of the controlled terminal;
a receiving module 1708, configured to receive a touch operation performed by a user on the second interactive interface;
a control module 1710, configured to control the controlled terminal to perform a touch response according to the touch operation;
a second acquisition module 1712, configured to acquire a first touch response interface of the controlled terminal, in which the first touch response interface is an interface displayed after the controlled terminal performs the touch response;
a second display module 1714, configured to display a second touch response interface, in which the second touch response interface matches the first touch response interface of the controlled terminal.

In the above terminal control device, a connection between the control terminal and the controlled terminal is established, the control terminal acquires the first interactive interface of the controlled terminal, and displays the second interactive interface according to the first interactive interface. Since the second interactive interface matches the first interactive interface, the information of the first interactive interface can be completely displayed; the touch operation on the second interactive interface is equivalent to the touch operation on the first interactive interface. After the controlled terminal performs the touch response according to the touch operation, the second touch response interface matching the touch response of the controlled terminal is displayed on the control terminal, accordingly the result of the touch response of the controlled terminal can be completely displayed. In the method, the interaction between the control terminal and the controlled terminal replaces the direct operation on the control terminal, thereby avoiding complex data processing procedures performed on the control terminal, and reducing the weights and volumes of the storage space and the data processing module of the control terminal, and solving the problems of larger weight and volume, and dissatisfied portability of the terminal in the conventional communication system.

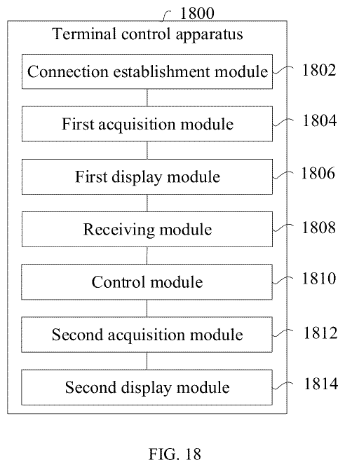

As shown in FIG. 18, in an embodiment, another terminal control apparatus is provided, including:
a connection establishment module 1802, configured to establish a connection with a control center, in which the connection is established between the control center and the controlled terminal;
a first acquisition module 1804, configured to acquire a first interactive interface of the controlled terminal through the control center;
a first display module 1806, configured to display a second interactive interface, in which the second interactive interface matches the first interactive interface of the controlled terminal;
a receiving module 1808, configured to receive a touch operation performed by a user on the second interactive interface;
a control module 1810, configured to transmit the touch operation to the control center, in which the control center is configured to control the controlled terminal to perform a touch response according to the touch operation;
a second acquisition module 1812, configured to acquire a first touch response interface of the controlled terminal through the control center, in which the first touch response interface is an interface displayed after the controlled terminal performs the touch response;
a second display module 1814, configured to display a second touch response interface, in which the second touch response interface matches the first touch response interface of the controlled terminal.

In the above terminal control apparatus, connections among the control terminal, the control center and the controlled terminal are established; the control terminal acquires the first interactive interface of the controlled terminal through the forwarding of the control center, and displays the second interactive interface according to the first interactive interface. Since the second interactive interface matches the first interactive interface, the information of the first interactive interface can be completely displayed; the touch operation on the second interactive interface is equivalent to the touch operation on the first interactive interface. The touch operation data is forwarded through the control center, and after the controlled terminal performs the touch response according to the touch operation, the second touch response interface matching the touch response of the controlled terminal is displayed on the control terminal, accordingly the result of the touch response of the controlled terminal can be completely displayed. In the method, the control terminal interacts with the controlled terminal through the control center, instead of directly operating the control terminal, thereby avoiding complex data processing procedures performed on the control terminal, and solving the problems of larger weight and volume, and dissatisfied portability of the terminal in the conventional communication system. Further, through the forwarding of the control center, the requirements of a long-distance communication can be satisfied. Further, the future development prospects of the communication system can be maximized, and complex problems caused by the existing terminal brands and operator configuration thresholds can be reduced.

In an embodiment, a computer device is provided, including a memory and a processor, in which the memory stores a computer program, and the processor executes the steps of the above terminal control method when the computer program is executed by the processor. The steps of the terminal control method here may be the steps in the terminal control methods of each foregoing embodiment.

In an embodiment, a computer-readable storage medium is provided, which stores a computer program, a processor executes the steps of the above terminal control method when the computer program is executed by the processor. The steps of the terminal control method here may be the steps in the terminal control methods of each of the above-mentioned embodiments.

Those of ordinary skill in the art can understand that all or part of the processes in the methods of the above embodiments can be implemented by instructing relevant hardware through a computer program, and the computer program can be stored in a non-transitory computer-readable storage medium, when the computer program is executed, the process may include the procedures of each of the above-mentioned method embodiments. Any reference to memory, storage, database or other medium used in the various embodiments provided in the present application may include non-transitory and/or transitory memory. Non-transitory memory may include a read only memory (ROM), a programmable ROM (PROM), an electrically programmable ROM (EPROM), an electrically erasable programmable ROM (EEPROM), or a flash memory. The transitory memory may include a random access memory (RAM) or an external cache memory. By way of illustration and not limitation, the RAM is available in various forms such as a static RAM (SRAM), a dynamic RAM (DRAM), a synchronous DRAM (SDRAM), a double data rate SDRAM (DDRSDRAM), an enhanced SDRAM (ESDRAM), a synchronous chain link (Synchlink) DRAM (SLDRAM), a memory bus (Rambus) direct RAM (RDRAM), a direct memory bus dynamic RAM (DRDRAM), and a memory bus dynamic RAM (RDRAM), etc.

The technical features of the above embodiments can be combined arbitrarily. For the sake of brevity, all possible combinations of the technical features in the above embodiments are not described. However, as long as there is no contradiction in the combination of these technical features, all should be considered to be the scope of the present application.

The above-mentioned embodiments are merely some embodiments of the present application, and the descriptions thereof are relatively specific and detailed, but should not be construed as a limitation to the scope of the present invention. It should be pointed out that those skilled in the art can make several modifications and improvements without departing from the concept of the present application, which all belong to the protection scope of the present application. Therefore, the scope of protection of the present application shall be subject to the appended claims.

1. A terminal control method, comprising:
establishing a connection with a controlled terminal;
acquiring a first interactive interface of the controlled terminal;
displaying a second interactive interface, the second interactive interface matching the first interactive interface of the controlled terminal;
receiving a touch operation performed by a user on the second interactive interface;
controlling the controlled terminal to perform a touch response according to the touch operation;
acquiring a first touch response interface of the controlled terminal, the first touch response interface being an interface displayed after the controlled terminal performs the touch response;
displaying a second touch response interface, the second touch response interface matching the first touch response interface of the controlled terminal.

2. The method according to claim 1, wherein the controlling the controlled terminal to perform the touch response according to the touch operation comprises:
obtaining touch operation data according to the touch operation;
obtaining touch operation data of the controlled terminal according to the touch operation data, wherein the touch operation data of the controlled terminal is configured to perform the touch operation on the first interactive interface of the controlled terminal;
transmitting the touch operation data of the controlled terminal to the controlled terminal, for performing the touch response by the controlled terminal according to the touch operation data of the controlled terminal, to obtain the first touch response interface of the controlled terminal.

3. The method according to claim 1, wherein the establishing the connection with the controlled terminal comprises:
establishing the connection with the controlled terminal through Wi-Fi, Bluetooth or a custom wireless protocol; or
wherein the establishing the connection with the controlled terminal further comprises:
acquiring an identity code;
transmitting the identity code to the controlled terminal, for establishing the connection by the controlled terminal after successfully verifying the identity code.

4. (canceled)

5. The method according to claim 1, wherein the acquiring the first interactive interface of the controlled terminal comprises:
acquiring interactive interface screenshot data, the interactive interface screenshot data being data obtained by performing screenshot of the first interactive interface of the controlled terminal;
processing the interactive interface screenshot data to obtain processed interactive interface screenshot data which is configured to display the second interactive interface; or
wherein the acquiring the first touch response interface of the controlled terminal comprises:
acquiring response interface screenshot data, the response interface screenshot data being data obtained by performing screenshot of the first touch response interface of the controlled terminal;
processing the response interface screenshot data to obtain processed response interface screenshot data, wherein the processed response interface screenshot data is configured to display the second touch response interface.

6. (canceled)

7. A terminal control method, comprising:
establishing a connection with a control center, wherein the connection is established between the control center and a controlled terminal;
acquiring a first interactive interface of the controlled terminal through the control center;
displaying a second interactive interface, the second interactive interface matching the first interactive interface of the controlled terminal;
receiving a touch operation performed by a user on the second interactive interface;
transmitting the touch operation to the control center, wherein the control center is configured to control the controlled terminal to perform a touch response according to the touch operation;
acquiring, through the control center, a first touch response interface of the controlled terminal, wherein the first touch response interface is an interface displayed after the controlled terminal performs the touch response;
displaying a second touch response interface, the second touch response interface matching the first touch response interface of the controlled terminal.

8. The method according to claim 7, wherein the establishing the connection with the control center comprises:
establishing the connection with the control center via a 3G/4G/5G network or Wi-Fi; or
wherein the establishing the connection with the control center further comprises:
acquiring an identity code;
transmitting the identity code to the control center; forwarding, through the control center, the identity code to the controlled terminal, for establishing the connection by the controlled terminal after successfully verifying the identity code.

9. (canceled)

10. The method according to claim 7, wherein the acquiring the first interactive interface of the controlled terminal through the control center comprises:
receiving a manipulation request of the controlled terminal, wherein the manipulation request of the controlled terminal is configured to request a manipulation of the controlled terminal by a user;
accessing the control center according to the manipulation request of the controlled terminal, and obtaining the first interactive interface of the controlled terminal.

11. The method according to claim 7, wherein the acquiring the first interactive interface of the controlled terminal through the control center further comprises:
acquiring interactive interface screenshot data through the control center, wherein the interactive interface screenshot data is data obtained by performing screenshot of the first interactive interface of the controlled terminal;
processing the interactive interface screenshot data to obtain processed interactive interface screenshot data, wherein the interactive interface screenshot data acquired by the control center is configured to display the second interactive interface.

12. The method according to claim 7, wherein the acquiring the first touch response interface of the controlled terminal through the control center comprises:
acquiring response interface screenshot data through the control center, wherein the response interface screenshot data is data obtained by performing screenshot of the first touch response interface of the controlled terminal;
processing the response interface screenshot data to obtain processed response interface screenshot data, wherein the processed response interface screenshot data is configured to display the second touch response interface.

13. A terminal control method, comprising:
establishing a connection with a control terminal;
transmitting a first interactive interface of the controlled terminal to the control terminal;
performing a touch response according to a touch operation, and obtaining a first touch response interface;
transmitting the first touch response interface to the control terminal.

14. The method according to claim 13, wherein the transmitting the first interactive interface of the controlled terminal to the control terminal comprises:
performing screenshot of the first interactive interface of the controlled terminal and obtaining interactive interface screenshot data;
transmitting the interactive interface screenshot data to the control terminal.

15. The method according to claim 13, wherein the transmitting the first touch response interface to the control terminal comprises:
performing screenshot of the first touch response interface and obtaining the response interface screenshot data;
transmitting the response interface screenshot data to the control terminal.

16. A terminal control method, comprising:
establishing a connection with a control center, wherein the connection is established between the control center and a control terminal;
transmitting a first interactive interface of a controlled terminal to the control terminal through the control center;
performing a touch response according to a touch operation, and obtaining a first touch response interface;
transmitting, through the control center, the first touch response interface to the control terminal.

17. The method according to claim 16, wherein the transmitting, through the control center, the first interactive interface of the controlled terminal to the control terminal comprises:
performing screenshot of the first interactive interface of the controlled terminal, and obtaining interactive interface screenshot data;
transmitting, through the control center, the interactive interface screenshot data to the control terminal.

18. The method according to claim 16, wherein the transmitting, through the control center, the first touch response interface to the control terminal comprises:
performing screenshot of the first touch response interface, and obtaining the response interface screenshot data;
transmitting, through the control center, the response interface screenshot data to the control terminal.

19. A terminal control system, comprising: a control terminal and a controlled terminal, the controlled terminal being configured to display a first interactive interface;
wherein the control terminal is configured to establish a connection with the controlled terminal;
the controlled terminal is configured to transmit the first interactive interface to the control terminal;
the control terminal is configured to display a second interactive interface matching the first interactive interface;
the control terminal is configured to receive a touch operation performed by a user on the second interactive interface;
the control terminal is configured to control the controlled terminal to perform a touch response according to the touch operation;
the controlled terminal is configured to transmit the first touch response interface to the control terminal;
the controlled terminal is configured to display a second touch response interface matching the first touch response interface of the controlled terminal.

20. A terminal control system, comprising: a control terminal, a control center and a controlled terminal;
wherein the control center is configured to establish a connection with the control terminal, and establish a connection with the controlled terminal;
the controlled terminal is configured to transmit a first interactive interface to the control center;
the control center is configured to forward the first interactive interface of the controlled terminal to the control terminal;
the control terminal is configured to display a second interactive interface matching the first interactive interface;
the control terminal is configured to receive a touch operation performed by a user on the second interactive interface;
the control terminal is configured to transmit the touch operation to the control center;
the control center is configured to control the controlled terminal to perform a touch response according to the touch operation;
the controlled terminal is configured to transmit the first touch response interface to the control center;
the control center is configured to forward the first touch response interface of the controlled terminal to the control terminal;
the control terminal is configured to display a second touch response interface matching the first touch response interface.

21. A terminal, comprising: a wireless communication interface, a touch display screen and a processor;
wherein the wireless communication interface is configured to establish a connection with a controlled terminal through a wireless communication manner;
the touch display screen is configured to display a second interactive interface, the second interactive interface matching the first interactive interface of the controlled terminal;
the touch display screen is configured to receive a touch operation performed by a user on the second interactive interface;
the processor is configured to control the controlled terminal to perform a touch response according to the touch operation, to display a first touch response interface;
the touch display screen is configured to display a second touch response interface, the second touch response interface matching the first touch response interface.

22. A terminal control apparatus, comprising:
a connection establishment module, configured to establish a connection with a controlled terminal;
a first acquisition module configured to acquire a first interactive interface of the controlled terminal;
a first display module configured to display a second interactive interface, the second interactive interface matching the first interactive interface of the controlled terminal;
a receiving module configured to receive a touch operation performed by a user on the second interactive interface;
a control module configured to control the controlled terminal to perform a touch response according to the touch operation;
a second acquisition module configured to acquire a first touch response interface of the controlled terminal, the first touch response interface is an interface displayed after the controlled terminal performs the touch response;
a second display module configured to display a second touch response interface, the second touch response interface matching the first touch response interface of the controlled terminal.

23. A terminal control apparatus, comprising:
a connection establishment module configured to establish a connection with a control center, wherein the connection is established between the control center and a controlled terminal;
a first acquisition module configured to acquire a first interactive interface of the controlled terminal through the control center;
a first display module configured to display a second interactive interface, the second interactive interface matching the first interactive interface of the controlled terminal;
a receiving module configured to receive a touch operation performed by a user on the second interactive interface;
a control module configured to transmit the touch operation to the control center, wherein the control center is configured to control the controlled terminal to perform a touch response according to the touch operation;
a second acquisition module configured to acquire a first touch response interface of the controlled terminal through the control center, wherein the first touch response interface is an interface displayed after the controlled terminal performs the touch response;
a second display module configured to display a second touch response interface, the second touch response interface matching the first touch response interface of the controlled terminal.

24-25. (canceled)
